(19) United States
(12) Patent Application Publication
(10) Pub. No.: US 2012/0024295 A1
(43) Pub. Date: Feb. 2, 2012

(54) Orthopedic device

(75) Inventor: William S. Mihin, Sandpoint, ID (US)

(73) Assignee: Mihin Chiropractic Clinic, LLC

(21) Appl. No.: 12/804,860

(22) Filed: Jul. 30, 2010

(51) Int. Cl. A61G 15/00

(52) U.S. Cl. 128/845

(57) ABSTRACT

An orthopedic device for treatment of headaches and the like includes a body adapted to substantially support a head of a human patient while the patient is resting in a substantially supine position. The body defines side surfaces, a lower surface and an upper surface. The upper surface defines a substantially convex protrusion substantially proximate to at least one side surface and a substantially concave depression substantially proximate to the protrusion. A difference in elevation between the protrusion and depression is selected to provide one or more beneficial treatment procedures to the patient.

### BACKGROUND

Headache pain and/or neck pain has been plaguing the human population throughout history. As is known within the medical field, and more specifically within the field of orthopedics, the causes of headache pain and/or upper neck pain can generally be substantially attributable to misalignment and/or disorientation of the skull or head with respect to the cervical spine, in at least a portion of cases.

Medical research into the causes and treatment of headache and/or upper neck pain due to such misalignment and/or disorientation has led to the development of one or more orthopedic therapy techniques and treatments intended to alleviate or relieve such pain. One such method is described in Kaufman, D. C., Stephen. “How to Relieve a Headache in Seconds on One Patient after Another!.” The American Chiropractor April 2009: 34-36. Print. While the prior art is replete with apparatus for assisting in spinal traction (e.g., U.S. Pat. No. 4,832,007), orthopedic pillows for supporting the head and spine during sleep (e.g., U.S. Published Patent Applications Nos. 2001/0029630 and 2006/0123549), and apparatus for making spinal adjustments (e.g., U.S. Published Patent Applications No. 2009/0222989), none of the prior art devices are specifically configured to alleviate headaches in the user according to the method described by Kaufman.

### DESCRIPTION OF THE DRAWINGS

FIG. 1 is an isometric view of an exemplary embodiment of the device described herein.

FIG. 2 is a side view of an exemplary embodiment of the device described herein.

FIG. 3 is a side view of an exemplary device and a partial view of a patient, with the patient depicted in an initial stage of an exemplary treatment according to one embodiment described herein.

FIG. 4 is a side view of the exemplary device of FIG. 3 and a partial view of a patient, with the patient depicted in a final stage of an exemplary treatment according to one embodiment described herein.

### DETAILED DESCRIPTION

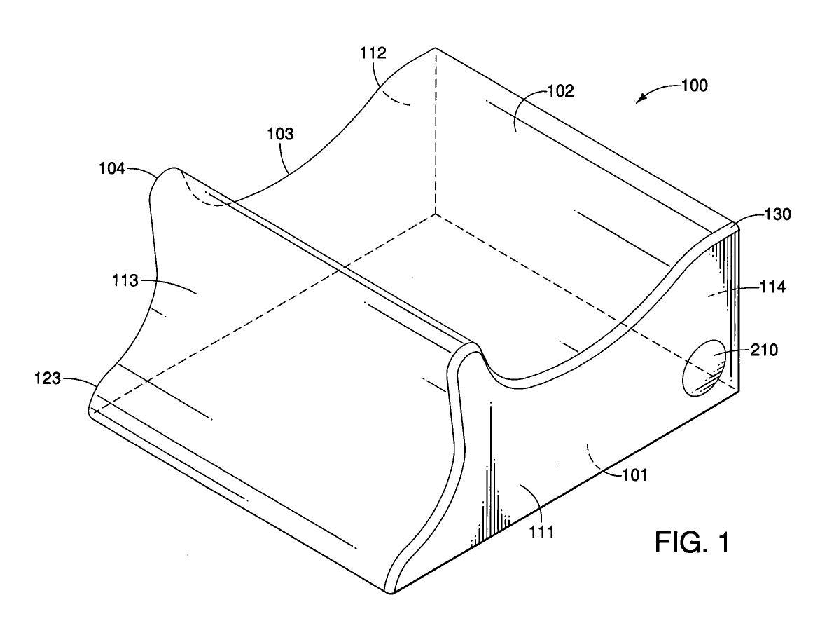

With reference to the drawing figures included herewith, FIG. 1 is an isometric view in which a device 100 is shown in accordance with an exemplary embodiment of the present disclosure. The device 100 can generally be described as an orthopedic device. More specifically, the device 100 can be described as an orthopedic device for treatment of headaches and the like in human patients. As is described in greater detail herein below, a typical use of the device 100 is to aid in, or to enable, treatment of headache pain or the like by at least partially supporting a patient's head, and/or by causing movement of a patient's head relative to the patient's spine, while the patient is in a substantially reclined or supine position.

The device 100, in accordance with the exemplary embodiment thereof depicted in FIG. 1, is substantially in the form of a shaped body. The body 100 has a lower surface 101. The lower surface can be substantially flat and/or planar. The lower surface 101 can have a substantially rectilinear outline, as shown. The body 100 can have an upper surface 102. The upper surface is distal from the lower surface 101. Specifically, the upper surface 102 can be in substantial juxtaposed orientation with respect to the lower surface 101. The upper surface 102 can have one or more conformational surface features. For example, the upper surface 102 can have a substantially concave depression 103. The depression 103 can be in the form of a trough, as shown. The upper surface 102 can have a substantially convex protrusion 104. The protrusion 104 can be substantially in the form of a ridge. The trough 103 and the ridge 104 can be substantially parallel to one another in accordance with the exemplary embodiment of the device 100, as shown. As is evident from a study of FIG. 1, an uppermost portion of the protrusion 104 is more distal from the lower surface 101 than the lowermost portion of the depression 103. One or more surfaces of the protrusion 104, such as for example the profile of the protrusion, can be described by, but not limited to, at least one of a circular segment, a segment of an ellipse, a hyperbolic arch, a catenary arch, and a segment of an irregular geometric ovoid form.

The body 100 includes a plurality of side surfaces such as a first side surface 111 and a second side surface 112, which extend between the lower surface 101 and the upper surface 102. In accordance with the exemplary embodiment of the device 100 depicted in FIG. 1, other examples of side surfaces include a front surface 113 and a rear surface 114. Each of the front surface 113 and the rear surface 114 extend between the lower surface 101 and the upper surface 102. The first side surface 111 is in offset juxtaposed orientation with respect to the second side surface 112. The first side surface 111 and the second side surface 112 each extend between the front surface 103 and the rear surface 104. Each of the side surfaces 111, 112 can be substantially flat or planar as shown. In accordance with the exemplary embodiment of the device 100, the front surface 113 and the rear surface 114 are in offset juxtaposed relation with respect to one another, as shown.

With continued reference to FIG. 1, it is evident that the protrusion 104 can be at least substantially proximate to at least one side surface 111, 112. The exemplary embodiment of the body 100 depicted in FIG. 1 is configured in a manner wherein the protrusion 104 is proximate to the front surface 113. In a similar manner, the depression 103 can be at least substantially proximate to at least one side surface 111, 112. As can be seen from the depiction of the exemplary embodiment of the device 100 of FIG. 1, the depression 103 can be proximate to the rear surface 114.

Further study of FIG. 1 reveals that the body 100 can include a stabilizer or stabilizer portion 123. As is more apparent from a reading of description of the device provided herein below, the stabilizer 123 can be adapted to resist tipping of the body 100 while the body is in use. The stabilizer 123 can be configured to extend substantially outwardly from at least one side surface (e.g., front surface 113) of the body 100. The at least one side surface from which the stabilizer 123 extends is substantially adjacent to the protrusion 104, according to at least one embodiment of the device 100. According to the exemplary embodiment of the device 100 shown in FIG. 1, at least a portion of the stabilizer 123 is integral with, or includes at least a portion of, the front surface 113. As is seen, the body 100 can be configured so that the front surface 113 bulges outwardly near the lower surface 101 to form a type of shoulder that is adapted to resist tipping of the body. That is, the front surface 113 can be shaped to slope generally downwardly and outwardly from the protrusion 104 in order to form the stabilizer 123. A length of the body 100 can be defined as a distance between the front surface 113 and the rear surface 114. An exemplary length dimension of the body is 23 centimeters. A width of the body 100 can be defined as a distance between the first side surface 111 and the second side surface 112. An exemplary width dimension of the body is 20 centimeters.

Still referring to FIG. 1, the device 100 can include a compliant material 130. The compliant material is preferably a resilient compliant material. The compliant material 130 is adapted to aid in comfort of the patient substantially at or near a point of contact between the patient's head or upper neck and the device 100. Specifically, the compliant material 130 is preferably selected to have a degree of softness sufficient to provide comfort to the patient during use, while also having a degree of stiffness sufficient to provide beneficial therapeutic effect to the patient according to the exemplary procedures described herein below. The compliant material 130 can be adapted to compress within a predetermined range of compression rates. For example, in accordance with one embodiment of the device 100, the compliant material 130 is adapted to compress not more than about 0.5 inch, and preferably not more than about 0.25 inch, when supporting a patient's head of average size during use of the device.

According to one embodiment of the device 100, the compliant material 130 can be a separate component affixed to the body 100. For example, as shown, the compliant material 130 can be substantially in the form of a layer that is affixed to, or otherwise supported on, at least a portion of the upper surface 102. The compliant material 130 can be affixed to, or otherwise supported on, at least a portion of one or more side surfaces (111, 112, 113, and/or 114) of the body 100. For example, as shown in FIG. 1, the compliant material 130 can be supported on the front surface 113.

According to at least one embodiment of the device 100, the compliant material 130 is a layer padding, such as foam padding, that is affixed to or otherwise supported on the upper surface 102 and the front surface 113. According to one or more alternative embodiments of the device 100, the compliant material 130 is substantially integral with the body 100 and/or substantially integral with at least a portion of the upper surface 102 of the body. Specifically, at least a portion of the body 100 can be fabricated from a compliant material 130 according to at least one embodiment of the device. For example, at least a portion of the body 100 that includes the protrusion 104 can be fabricated from the compliant material 130.

The device 100 can include a covering (not shown) adapted to line at least a portion of the upper surface 102. Such a covering can be, for example, substantially in the form of a vinyl sheet or cloth sheet affixed to, or otherwise supported on, at least a portion of the upper surface 102. Such a covering can be at least substantially integral with, or at least substantially permanently affixed to, the compliant material 130. Alternatively, the compliant material 130 can be substantially in the form of a covering such as a padded sheet of vinyl or padded cloth. According to at least one embodiment of the device 100, the compliant material 130 (and/or a covering as described above) can be removably affixed to the upper surface 102 (e.g., via a hook-and-loop fastening system such as that know by the trade name, Velcro®). In this manner, the compliant material 130 and/or a covering can be removed for washing and/or can be replaced.

It is to be understood that one or more of the surfaces described and/or depicted herein can have at least one of a number of various alternative configurations according to various respective alternative embodiments of the device 100. For example, one or more of the surfaces (for example, but not limited to 101, 111, 112 and 114) can be completely solid, or completely open, or partially open/partially solid. More specifically, for example, at least one surface can be at least substantially in the form of an open plane defined by respective adjoining edges of adjacent surfaces. As an alternative example, at least one surface can define one or more holes, or openings, or apertures. As yet a further example, at least one surface can be substantially made up of, or defined by, one or more elongate elements such as struts or the like. According to at least one embodiment of the device 100, such elongate elements can be arranged in a lattice or truss or framework or the like. Moreover, according to respective alternative embodiments thereof, the body 100 can be substantially hollow, or substantially solid, or partially hollow/partially solid. According to at least one alternative embodiment of the device 100, the upper surface 102 is supported by a substantially open support or framework made up of one or more elements such as, but not limited to, elements 101, 111, 112, and 114. In accordance with at least one specific variation of such an alternative embodiment, the upper surface 102 is at least substantially supported by a substantially open space frame. At least one of the elements of the body 100 can be substantially rigid or can be substantially compliant or non-rigid.

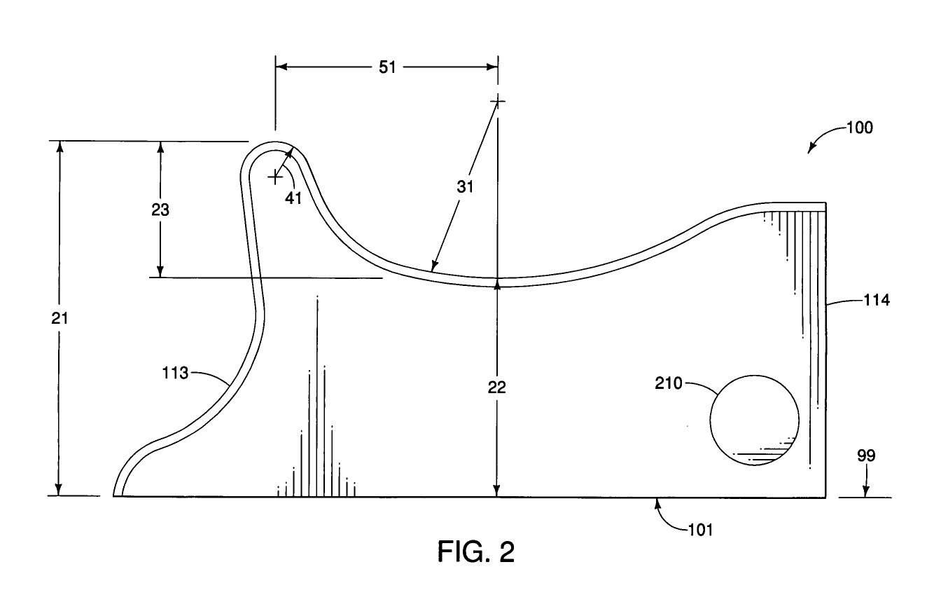

Turning now to FIG. 2, a side elevation view shows an alternative embodiment of the device 100 in accordance with which the compliant material 130 (shown in FIG. 1) is omitted. As is seen from a study of FIG. 2, the device 100 of FIG. 2 can be adapted for substantial contact with a base 99. According to at least one embodiment of the device 100, the lower surface 101 thereof is adapted for substantial contact with the base 99. The base 99 can have at least one of a number of possible specific forms or configurations. For example, the base 99 can be a tabletop or a floor. The device 100 can be adapted to be supported on the base 99 while the device is in use. In accordance with at least one method of using the device 100, the base 99 is substantially flat and substantially level. An exemplary base 99 is substantially stable and is of sufficient strength to support both the device 100 and a patient (not shown) while the device is employed in treatment of the patient according to one or more manners of use described herein.

As is evident from a study of FIG. 2, the device 100 can include a weight 210. In accordance with at least one embodiment of the device 100, the weight 210 is adapted to resist tipping of the device while the device is in use. Specifically, the weight 210 is configured and/or located with respect to the device 100 so as to aid in keeping the device in an upright orientation as shown in FIG. 2, while the device is in use. The weight 210 can have one or more of a number of specific configurations. For example, the weight can have one of a number of possible shapes such as the round or cylindrical shape shown in FIG. 2. Other shapes of the weight are within the scope of the one or more inventions described herein. The weight 210 can be a distinct object as is seen from a study of FIG. 2. Alternatively, the weight can be at least substantially integrated with another portion and/or part of the device 100. The weight 210 is located substantially proximate the rear side 114 and/or proximate the lower surface 101 according to the exemplary embodiment of the device 100. In accordance with at least one embodiment of the device, the weight 210 is located substantially as far as practicable from the front side 113.

With further reference to FIG. 2, it is seen that a first elevation dimension 21 is defined between the lower surface 101 of the device 100 and an uppermost portion of the protrusion 104. A second elevation dimension 22 is defined between the lower surface 101 and a lowermost portion of the depression 103. Moreover, a third elevation dimension 23 is defined between the uppermost portion of the protrusion 104 and the lowermost portion of the depression 103. As an alternative manner of description, the third elevation dimension 23 is equal to the difference between the first elevation dimension 21 and the second elevation dimension 22.

Continued reference to FIG. 2 reveals that the depression 103 can be characterized by a substantially concave radius of curvature 31. The protrusion 104 can be characterized by a substantially convex radius of curvature 41. A lateral dimension 51 is defined between the uppermost portion of the protrusion 104 and the lowermost portion of the depression 103. In accordance with the exemplary embodiment of the device shown in FIG. 2, the first elevation dimension 21 and the second elevation dimension 22 are defined along parallel lines of measure. In accordance with at least one embodiment of the device 100, the first elevation dimension 21 and the second elevation dimension 22 are defined along respective lines of measure that are perpendicular to the lower surface 101. The lateral dimension 51 is defined along a line of measure that is perpendicular to the first elevation dimension 21 and to the second elevation dimension 22.

Still referring to FIG. 2, and according to an exemplary embodiment of the device 100, a ratio of the first elevation dimension 21 to the second elevation dimension 22 is within a range of about 0.9 to 2.0. The first elevation dimension 21 of the exemplary embodiment is within a range of about 3.5 inches to about 5.0 inches. The second elevation dimension 22 of the exemplary embodiment is within a range of about 2.5 inches to about 4.0 inches. The third elevation dimension 23 of the exemplary device 100 is within a range of about 1.0 inch to about 1.5 inches. The lateral dimension 51 of the exemplary device 100 is within a range of about 2.5 inches to about 4.0 inches. The concave radius of curvature 31 of the exemplary device is within a range of 2.0 inches to about 5.0 inches. The convex radius of curvature 41 of the exemplary device 41 is within a range of about 1.5 inches to about 2.0 inches.

With reference to FIG. 2, it is to be understood that alternative dimensions are possible other than those specifically provided and/or described. That is, devices characterized by one or more dimensions falling outside of the exemplary ranges provided and/or described herein can still be within the scope of one or more inventions covered by the present disclosure. More specifically, as is described in greater detail herein below, the first elevation dimension 21 and the second elevation dimension 22 are selected according to at least one embodiment of the device to: initially cause an upper portion of a patient's neck between a lower portion of the patient's occipital bone and axis and atlas bones at a top of the patient's spine to be supported substantially by the protrusion 104 so that the patient's head is substantially suspended above the depression 103; and, to thereafter allow the patient's head to eventually settle into the depression to thereby be at least partially supported, whereby the patient's skull is substantially moved away from the patient's cervical spine in combined longitudinal and vertical directions with respect to the base of the patient's occipital bone.

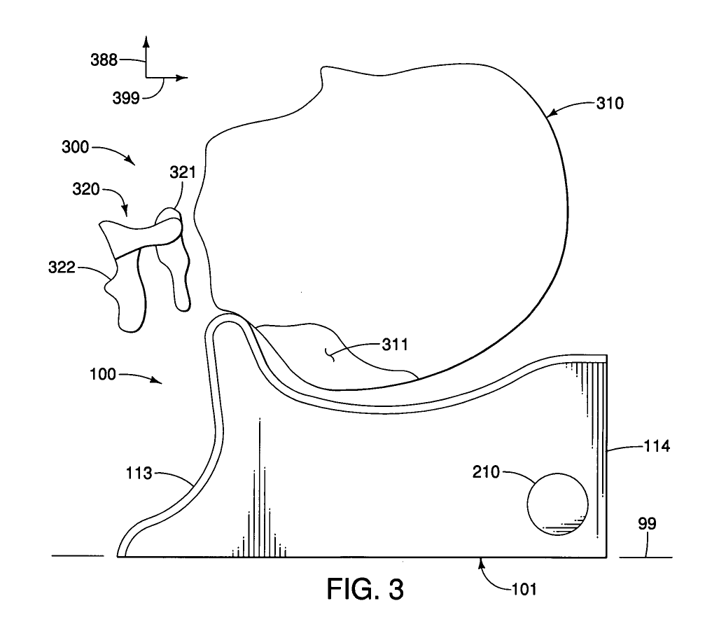

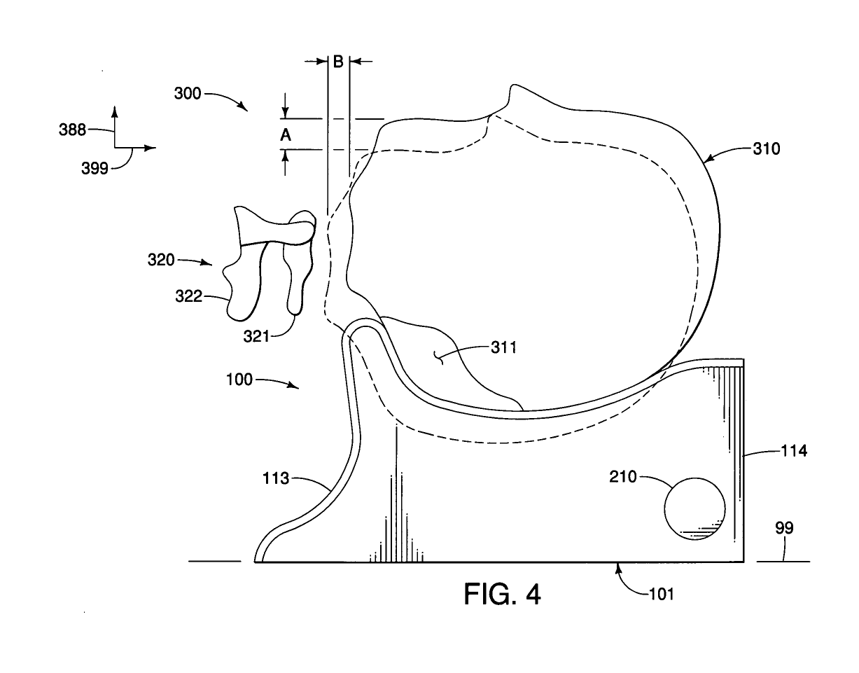

Turning now to FIGS. 3 and 4, a series of side elevation views of the device 100 illustrate a sequence of stages in an exemplary treatment procedure. Specifically, FIG. 3 shows an initial stage of an exemplary treatment procedure, while FIG. 4 shows a subsequent stage of an exemplary treatment procedure. In FIGS. 3 and 4, the device 100 is shown in use by a human patient 300. A partial view of the patient 300 is provided. Specifically, FIGS. 3 and 4 include respective side views of the patient's head or skull 310 and a portion of the patient's upper or cervical spine 320. The respective views of the patient 300 provided in FIGS. 3 and 4 show the rear or occipital region 311 of the head or skull 310. This rear or occipital region of the skull is also known as the occiput. The respective views of the patient 300 provided in FIGS. 3 and 4 also show the atlas vertebrae 321 and the axis vertebrae 322 of the upper or cervical spine 320.

As is shown in FIG. 3, the patient 300 assumes a substantially supine position and the patient's head 310 is generally brought to rest substantially upon the protrusion 104. According to an exemplary embodiment of the device 100, the device is supported on a base 99 and the patient lies down on the base with the patient's head 310 positioned on the device substantially as shown in FIG. 3. Specifically, the base of the occipital region 311 of the patient's head 310 is supported on the protrusion 104 in the manner shown. It is to be noted that in this initial position illustrated in FIG. 3, the patient's head 310 is supported substantially by the protrusion 104 so that the occipital region 311 is above, or not substantially supported by, the depression 103. The patient 300 is allowed to relax in the supine position for several minutes, during which time the patient's head eventually settles into the depression 103 as is illustrated by FIG. 4. Specifically, the patient's occiput 311 is allowed to eventually settle into a substantially nested position within the depression 103, wherein the occiput is at least partially supported by the depression.

An effect of the difference in respective positions of the patient's head 310 relative to the device 100 as illustrated by FIGS. 3 and 4 is that the patient's skull substantially disengages from the upper cervical spine 320 when the head is allowed to settle into the depression 103 from its initial position of being supported above the depression. According to at least one intended use of the device 100, the patient's lower occiput 311 is brought into contact with the protrusion 104 so that the patient's head 310 is initially supported above the depression 103 as is illustrated by FIG. 3. The patient 300 is allowed to relax for several minutes in this position, during which relaxation period the patient's head 310 gradually settles downwardly and into a substantially cradled position within the depression 103 as is illustrated by FIG. 4. Movement of the patient's head in this manner can cause disengagement of the patient's occiput 311 from the upper cervical spine 321, and can cause anterior and/or superior movement of the occiput relative to the atlas/axis complex. More specifically, with reference to FIGS. 3 and 4, anterior movement of the head 310 relative to the spine 320 can be defined as movement in a direction generally indicated by the arrow marked 388, while superior movement can be defined as movement in a direction generally indicated by the arrow marked 399. With reference now to FIG. 4, dimensions marked “A” and “B” indicate an extent of movement of the patient's head 310 relative to the spine 320 in the anterior direction 388 and superior direction, respectively. It is to be noted that an initial position of the head 310 (relative to the spine 320) is indicated by phantom line in FIG. 4. It is seen in FIG. 4 that as a result of treatment using the device 100, the patient's head 310 has moved in the anterior direction 388 as well as the superior direction 399. More specifically, the patient's head 310 has moved a distance “A” relative to the spine 320 in the anterior direction 388. Likewise, as a result of the treatment, the patient's head 310 has moved a distance “B” relative to the spine 320 in the superior direction 399. It is to be understood that the distances “A” and “B” have been exaggerated for illustrative purposes and that such distances may not be attainable in actual practice.

Disengagement of the skull 310 from the upper cervical spine 320 by way of one or more methods and/or use of one or more devices described herein is accompanied by superior and/or anterior movement or repositioning of the skull relative to the upper spine. Such repositioning of the skull 310 relative to the upper spine 320 allows the skull to effectively float freely relative to the spine. Repositioning of the skull 310 relative to the upper spine 320 can allow relaxation of the upper cervical musculature (not shown), which in turn allows the cervical musculature to reset to a new physiological position. The new reset position of the cervical musculature can have many beneficial effects including increases in venous and lymphatic drainage from the skull, improvement in circulation and parasympathetic stimulation via the vagus nerve, which can lead to a reduction in blood pressure. Such effects can lead to a reduction and/or elimination of headaches including both tension and migraine types.

Still referring to FIGS. 3 and 4, it is to be understood that alternative means of supporting the device 100 and/or the patient 300 are contemplated within the scope of the one or more inventions described and/or illustrated herein. For example, both the device 100 and the patient 300 can be substantially supported on the base 99. Alternatively, the device 100 is supported on the base 99, while the patient 300 is at least partially supported by means other than the base. In accordance with at least one method of using the device 100, the base 99 is substantially horizontally oriented, while according to at least one alternative method, the base is not horizontally oriented. For example, according to at least one alternative method of treatment, the device 100 is supported on a base 99 that is at least slightly inclined.

The preceding description has been presented only to illustrate and describe exemplary methods and apparatus of the present invention. It is not intended to be exhaustive or to limit the disclosure to any precise form disclosed. Many modifications and variations are possible in light of the above teaching. It is intended that the scope of the current disclosure be defined by the following claims.

What is claimed is:

1. An orthopedic device for treatment of headaches and the like, comprising a body adapted to substantially support a head of a human patient while the patient is resting in a substantially supine position, the body comprising:
a lower surface adapted for substantial contact with a base;
an upper surface distal from and in substantial juxtaposed orientation with respect to the lower surface;
a plurality of side surfaces extending between the lower surface and the upper surface;
the upper surface defining a substantially convex protrusion substantially adjacent to at least one side surface, and a substantially concave depression substantially adjacent the protrusion, wherein:
a first elevation dimension is defined between the lower surface and an uppermost portion of the protrusion;
a second elevation dimension is defined between the lower surface and a lowermost portion of the depression; and
the first and second elevation dimensions are selected to initially cause the patient's head to be supported substantially by the protrusion whereby the patient's head is substantially suspended above the depression, and to thereafter allow the patient's head to eventually settle into the depression to thereby be at least partially supported, whereby the patient's skull is substantially moved away from the patient's cervical spine in combined anterior and superior directions with respect to the spine.

2. The device according to claim 1, wherein a ratio of the first elevation dimension to the second elevation dimension is within a range of about 0.9 to 2.0.

3. The device according to claim 1, wherein the first elevation dimension is within a range of about 3.5 inches to about 5.0 inches.

4. The device according to claim 1, wherein the second elevation dimension is within a range of about 2.5 inches to about 4.0 inches.

5. The device according to claim 1, wherein:
the first elevation dimension is within a range of about 3.5 inches to about 5.0 inches; and
the second elevation dimension is within a range of about 2.5 inches to about 4.0 inches.

6. The device according to claim 1, wherein a third elevation dimension is defined between the uppermost portion of the protrusion and the lowermost portion of the depression, and is within a range of about 1.0 inch to about 1.5 inches.

7. The device according to claim 1, wherein a lateral dimension is defined between the uppermost portion of the protrusion and the lowermost portion of the depression, and is within a range of about 2.5 inches to about 4.0 inches.

8. The device according to claim 1, wherein:
a third elevation dimension is defined between the uppermost portion of the protrusion and the lowermost portion of the depression, and is within a range of about 1.0 inch to about 1.5 inches; and
a lateral dimension is defined between the uppermost portion of the protrusion and the lowermost portion of the depression, and is within a range of about 2.5 inches to about 4.0 inches.

9. The device according to claim 1, wherein the protrusion is characterized by a convex radius of curvature within a range of about 1.5 inches to about 2.0 inches.

10. The device according to claim 1, wherein the depression is characterized by a concave radius of curvature within a range of about 2.0 inches to about 5.0 inches.

11. The device according to claim 1, wherein:
the protrusion is characterized by a convex radius of curvature within a range of about 1.5 inches to about 2.0 inches; and
the depression is characterized by a concave radius of curvature within a range of about 2.0 inches to about 5.0 inches.

12. The device according to claim 1, wherein:
a third elevation dimension is defined between the uppermost portion of the protrusion and the lowermost portion of the depression, and is within a range of about 1.0 inch to about 1.5 inches;
a lateral dimension is defined between the uppermost portion of the protrusion and the lowermost portion of the depression, and is within a range of about 2.5 inches to about 4.0 inches;
the protrusion is characterized by a convex radius of curvature within a range of about 1.5 inches to about 2.0 inches; and
the depression is characterized by a concave radius of curvature within a range of about 2.0 inches to about 5.0 inches.

13. The device according to claim 1, comprising a weight adapted to resist tipping of the device when in use.

14. The device according to claim 1, comprising a weight having a position laterally distal from the protrusion such that the depression is substantially between the weight and the protrusion.

15. The device according to claim 1, comprising a stabilizer extending substantially outwardly from the at least one side surface to which the protrusion is substantially adjacent, the stabilizer being adapted for contact with the base to thereby resist tipping of the body.

16. The device according to claim 1, wherein the protrusion comprises a compliant material adapted to compress not more than about 0.5 inches when supporting at least a portion of the patient during intended use of the device.

17. An orthopedic device for treatment of headaches and the like, comprising a body adapted to substantially support a head of a human patient while the patient is resting in a substantially supine position upon a substantially flat base, the body comprising:
a lower surface adapted for substantial contact with the base;
an upper surface distal from, and in substantial juxtaposed relation to, the lower surface, and adapted for substantial contact with the head of the patient;
a front surface extending between the lower surface and the upper surface;
a rear surface in offset juxtaposed orientation with respect to the front surface, and extending between the lower surface and the upper surface;
a first side surface extending between the lower surface, the upper surface, the front surface and the rear surface;
a second side surface in offset juxtaposed orientation with respect to the first side surface, and extending between the lower surface, the upper surface, the front surface and the rear surface;
the upper surface defining a substantially upwardly protruding ridge having a substantially convex uppermost portion, the ridge being substantially adjacent to the front surface, the upper surface further defining a substantially concave trough having a substantially concave lowermost portion, the trough being located substantially between the rear side and the ridge, the ridge and the trough being substantially parallel, wherein:
a first elevation dimension is defined between the lower surface and the uppermost portion of the protrusion;
a second elevation dimension is defined between the lower surface and the lowermost portion of the depression;
the first and second elevation dimensions are selected to initially cause the patient's head to be supported substantially by the protrusion whereby the head is substantially suspended above the depression, and to thereafter allow the patient's head to eventually settle into the depression to thereby be at least partially supported, whereby the patient's skull is substantially moved away from the patient's cervical spine in combined anterior and superior directions with respect to the spine;
the first elevation dimension is within a range of 1.0 inch to 1.5 inches; and
the second elevation dimension is within a range of 2.5 inches to 4.0 inches.

18. The device according to claim 17, wherein a lateral dimension defined between the uppermost portion of the ridge and the lowermost portion of the trough is within a range of 2.5 inches to 4.0 inches.

19. The device according to claim 17, wherein:
the uppermost portion of the ridge is characterized by a convex radius of curvature within a range of 1.5 inches to 2.0 inches; and
the lowermost portion of the depression is characterized by a concave radius of curvature within a range of 2.0 inches to about 5.0 inches.

20. The device according to claim 17, wherein the protrusion is adapted to support the patient's head by contacting the head substantially in the lower region of the patient's occiput.
